(19) United States
(12) Patent Application Publication
(10) Pub. No.: US 2006/0190637 A1
(43) Pub. Date: Aug. 24, 2006

(54) Control apparatus, information processing apparatus, and data transferring method

(75) Inventors: Yasunori Maki, Iruma-shi (JP); Kenichi Ishii, Ome-shi (JP); Hirotaka Suzuki, Ome-shi (JP); Yoshinobu Kimura, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/337,508

(22) Filed: Jan. 24, 2006

(30) Foreign Application Priority Data
Feb. 4, 2005 (JP) 2005-028946

(51) Int. Cl. G06F 13/28

(52) U.S. Cl. 710/22

(57) ABSTRACT

A control apparatus has a memory, a processor, an input/output controller, and an interrupt controller. The processor is accessible to the memory. The input/output controller starts to transfer data from an input/output device to write the data to a given area in the memory not through the processor, reads data out of the given area in the memory after last data is transferred, and issues an interrupt indicative of completion of data transfer after confirming that all of the transferred data has been written to the memory by confirming a response. The interrupt controller receives the interrupt from the input/output controller and transmits the interrupt to the processor.

### CROSS-REFERENCE TO RELATED APPLICATIONS

This application is based upon and claims the benefit of priority from prior Japanese Patent Application No. 2005-028946, filed Feb. 4, 2005, the entire contents of which are incorporated herein by reference.

### BACKGROUND OF THE INVENTION

1. Field of the Invention

The present invention relates to a control apparatus for controlling data transfer from an input/output device to a memory, an information processing apparatus, and a data transferring method.

2. Description of the Related Art

In an information processing apparatus such as a personal computer, a data transfer system called direct memory access (DMA) is generally adopted for data transfer between a main memory and an input/output device such as an HDD. In this system, data is transferred between an input/output device and a memory not through a CPU, so that the entire system can be increased in speed. In order to transfer data, however, the CPU needs to be notified of the data transfer. If data is written to the main memory at the request of the input/output device, an input/output controller that controls the input/output device issues an interrupt to the CPU. Thus, the CPU can read the data out of the main memory and perform necessary operations.

The input/output controller has to issue an interrupt to the CPU in a timely manner after write access is gained to the main memory. If an interrupt is issued to the CPU too early, the CPU will read data out of the main memory before all data is completely written to the main memory, with the result that data consistency cannot be ensured. In order to avoid this, it can be thought to employ the technique disclosed in, for example, Jpn. Pat. Appln. KOKAI Publication No. 7-210500.

The above Publication discloses the following. When data is transferred from an input/output control device connected to a local bus to a main memory connected to a system bus through a buffer by DMA, it is determined whether data transfer is completed or not by detecting the signal status of the system bus or setting a fixed period of time to a timer. When the data transfer is completed, an interrupt is issued to a CPU.

However, the technique of the above Publication is intended not to confirm that data write to the main memory is actually completed, but simply to predict completion of data write to the main memory indirectly from the signal status of the bus. For this reason, there still remains a possibility that an interrupt will be issued to the CPU immediately before data write to the main memory is actually completed. It is hard to say that data consistency can be secured with reliability.

Under the circumstances, it is desired to provide a technique capable of reliably securing consistency of data to be transferred between an input/output device and a memory.

### BRIEF SUMMARY OF THE INVENTION

According to one aspect of the present invention, there is provided a control apparatus comprising a memory; a processor which is accessible to the memory; an input/output controller which starts to transfer data from an input/output device to write the data to a given area in the memory not through the processor, reads data out of the given area in the memory after last data is transferred, and issues an interrupt indicative of completion of data transfer after confirming that all of the transferred data has been written to the memory by confirming a response; and an interrupt controller which receives the interrupt from the input/output controller and transmits the interrupt to the processor.

According to another aspect of the present invention, there is provided an information processing apparatus comprising a memory; a processor which is accessible to the memory; a data transfer unit which transfers data to the memory not through the processor; an input/output controller which starts to transfer data from an input/output device to write the data to a given area in the memory not through the processor but through the data transfer unit, reads data out of the given area in the memory after last data is transferred, and issues an interrupt indicative of completion of data transfer after confirming that all of the transferred data has been written to the memory; and an interrupt controller which receives the interrupt from the input/output controller and transmits the interrupt to the processor.

According to still another aspect of the present invention, there is provided a data transferring method applied to an apparatus including a memory and a processor accessible to the memory, the method comprising starting to transfer data from an input/output device to write the data to a given area in the memory not through the processor; and reading data out of the given area in the memory after last data is transferred and transmitting an interrupt indicative of completion of data transfer to the processor after confirming that all of the transferred data has been written to the memory.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of principal components of an information processing apparatus according to an embodiment of the present invention;

FIG. 2 is a block diagram of the internal structure of an input/output controller in the information processing apparatus shown in FIG. 1;

FIG. 3 is a block diagram of a data transfer unit included in the information processing apparatus shown in FIG. 1;

FIG. 4 is a diagram showing an example of a system configured when the information processing apparatus shown in FIG. 1 is implemented as a server apparatus;

FIG. 5 is a flowchart showing a startup operation performed before DMA data transfer; and

FIG. 6 is a flowchart showing a DMA data transfer operation.

### DETAILED DESCRIPTION OF THE INVENTION

Embodiments of the present invention will be described below with reference to the drawings.

FIG. 1 is a block diagram of principal components of an information processing apparatus according to an embodiment of the present invention.

FIG. 1 shows an information processing apparatus 1 that is, for example, a personal computer. It includes a main memory 11, a central processing unit (CPU) 12, an input/output device 13, an input/output controller 14, an interrupt controller 15, a first system bus 16, a second system bus 17, a first bridge unit 18 and a second bridge unit 19.

The main memory 11 includes a nonvolatile memory such as a random access memory (RAM) and is used for storing various programs and data. There is a case where data transferred by DMA from the input/output device 13 is written to the main memory 11.

The CPU 12 controls the entire operation of the information processing apparatus 1 and can gain access to the main memory 11 and the like. Upon receipt of a given interrupt from the interrupt controller 15, the CPU 12 recognizes that data has been transferred to the main memory 11 by DMA. In this case, the CPU 12 reads the transferred data out of the main memory 11 as needed.

The input/output device 13 corresponds to a hard disk drive (HDD) or the like. In transferring data to the main memory 11, the input/output device 13 issues an interrupt to the input/output controller 14 when the data transfer is completed.

The input/output controller 14 controls the input/output of data to/from the input/output device 13. The input/output controller 14 transfers data from the input/output device 13 in order to write the data to a given area in the main memory 11 not through the CPU 12. Upon receiving the last data from the input/output device 13, the input/output controller 14 senses an interrupt issued from the device 13. The input/output controller 14 does not output the interrupt to the interrupt controller 15 immediately after it senses the interrupt, but reads data from a given area in the main memory 11. Then, the input/output controller 14 issues an interrupt indicative of the completion of data transfer by confirming that all the transferred data is written to the main memory 11.

The interrupt controller 15 receives various interrupts from inside the information processing apparatus 1 and transmits them to the CPU 12. This interrupt controller 15 can be built in the second bridge unit 19 or the like.

The first system bus 16 corresponds to, for example, a peripheral component interconnect (PCI) bus. The first system bus 16 is used to transfer data between the first and second bridge units 18 and 19.

The second system bus 17 corresponds to, for example, a low pin count (LPC) bus. The second system bus 17 is used to transfer data between the second bridge unit 19 and the input/output controller 14.

The first bridge unit 18 serves as a bridge linking the first system bus 16 to the main memory 11, CPU 12 and interrupt controller 15 and has a buffer for data transfer to allow data to be transferred bidirectionally. The first bridge unit 18 has a function of transferring data by DMA in cooperation with the second bridge unit 19. The first bridge unit 18 also has a function of receiving a write command to write data to the main memory 11 and a read command to read data from the main memory 11 from the input/output controller 14 at the time of DMA data transfer and returning these commands to the input/output controller 14.

The second bridge unit 19 serves as a bridge linking the first system bus 16 to the second system bus 17 and has a buffer for data transfer to allow data to be transferred bidirectionally. The second bridge unit 19 has a function of transferring data by DMA in cooperation with the first bridge unit 18.

Of the foregoing components, at least the main memory 11, CPU 12, input/output controller 14 and interrupt controller 15 constitute a control apparatus for controlling data transfer according to the embodiment of the present invention.

In addition to the input/output device 13, for example, a communication unit for communicating with another device via an external network can be provided. In this case, another input/output controller for controlling the input/output of data to/from the communication unit is provided.

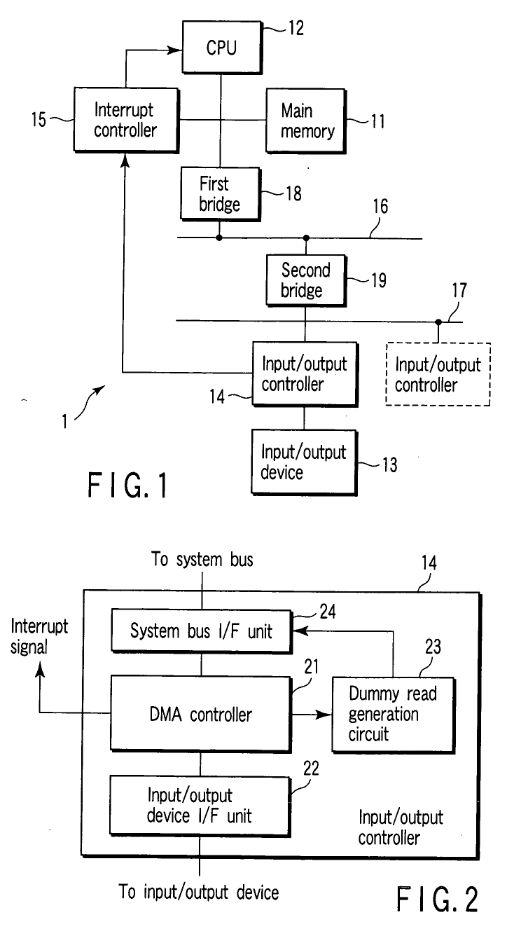

FIG. 2 is a block diagram of the internal structure of the input/output controller 14 in the information processing apparatus shown in FIG. 1.

Referring to FIG. 2, the input/output controller 14 includes a DMA controller 21, an input/output device interface unit 22, a dummy read generation circuit 23 and a system bus interface unit 24.

The DMA controller 21 controls the entire operation of the input/output controller 14. The DMA controller 21 issues a write command to write data, which is sent from the input/output device 13 through the system bus interface unit 24, to a given area in the main memory 11, and starts to transfer data by DMA.

The DMA controller 21 receives an interrupt from the input/output device 13 after the last data is transferred by DMA and does not issue it to the controller 15 immediately. The DMA controller 21 instructs the dummy read generation circuit 23 to issue a read command to read data out of the given area in the main memory 11 immediately after the input/output device 13 issues an interrupt. After the dummy read generation circuit 23 issues a read command to the second system bus 17 through the system bus interface unit 24, the DMA controller 21 receives a response to the read command through the system bus interface unit 24 to confirm that data has been completely written to a given area in the main memory 11. Then, the DMA controller 21 issues an interrupt indicative of the completion of DMA data transfer to the controller 15 (shown in FIG. 1).

The input/output device interface unit 22 serves as an interface between the DMA controller 21 and the input/output device 13 (shown in FIG. 1). Upon receiving an interrupt from the input/output device 13, the input/output device interface unit 22 transmits the interrupt to the DMA controller and sends data from the input/output device 13 to the DMA controller 21.

The dummy read generation circuit 23 is responsive to an instruction from the DMA controller 21. In response to the instruction, the dummy read generation circuit 23 issues a read command to read data out of the given area in the main memory 11 to the second system bus 17 through the system bus interface unit 24.

The system bus interface unit 24 serves as an interface between the DMA controller 21 and the second system bus 17. For example, the system bus interface unit 24 sends a write command, which is issued from the DMA controller 21, to the system bus 17, sends a read command, which is issued from the dummy read generation circuit 23, to the system bus 17, and transmits a response to each of these commands from the second system bus 17 to the DMA controller 21.

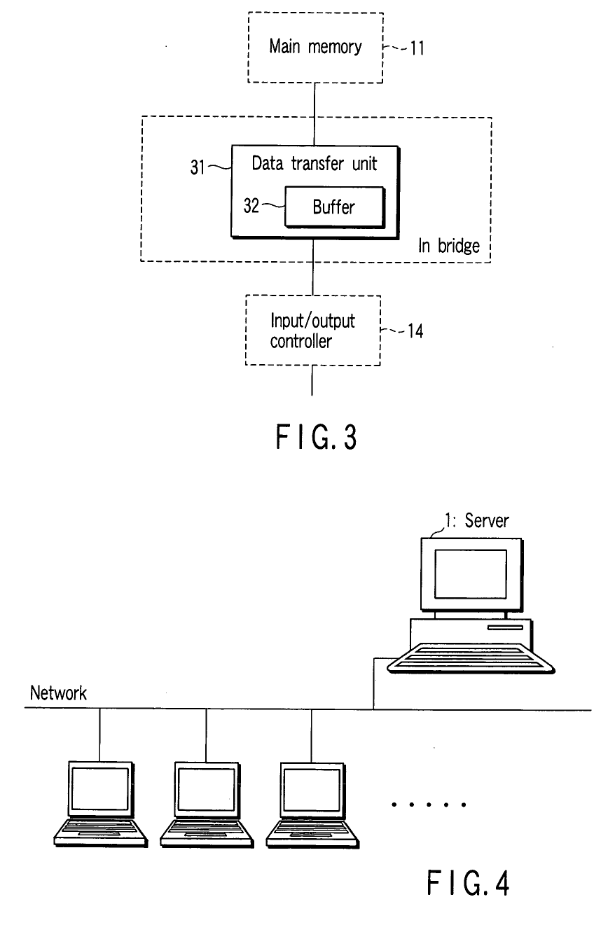

FIG. 3 shows a configuration of a data transfer unit 31 included in the information processing apparatus 1.

The data transfer unit 31 includes a transfer buffer 32 to transfer data between the main memory 11 and the input/output controller 14. The data transfer unit 31 has a function of DMA data transfer as described above. The data transfer unit 31 is built in the first bridge unit 18, the second bridge unit 19 and the like.

FIG. 4 is a diagram showing an example of a system configured when the information processing apparatus 1 is implemented as a server apparatus.

When the information processing apparatus 1 operates as a server, it receives various requests from another information processing apparatus and a peripheral device (client) via a network and transfers data. The information processing apparatus 1 is configured such that it can transfer data to the main memory 11 by DMA based on the configurations shown in FIGS. 1 to 3.

The information processing apparatus 1 operating as a server is not limited to a personal computer but can be directed to, for example, a printer. In this case, the apparatus 1 includes not only the input/output device 13 but also, for example, a communication device for communicating with another device through an external network and an input/output controller for controlling input/output of data to/from the communication device. When another information processing apparatus transmits data (document data to be printed) to the information processing apparatus 1 through the network, the data is transferred to the main memory 11 by DMA through the communication device and the input/output controller (having the same configuration as that of the input/output controller 14 shown in FIG. 3).

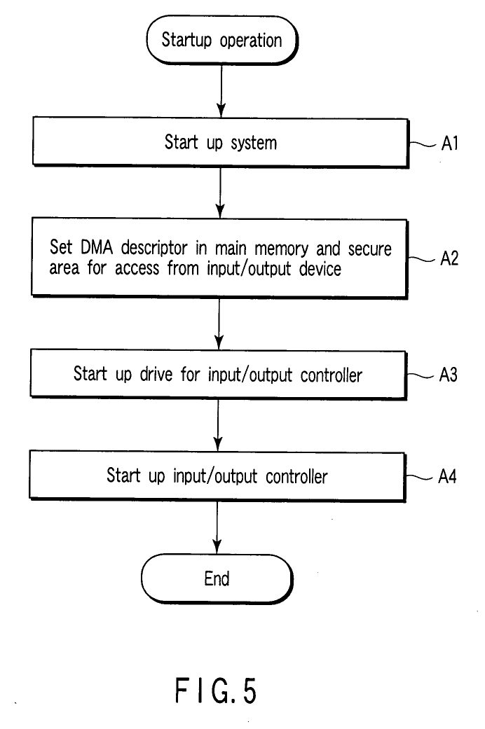

A startup operation performed before DMA data transfer in the present embodiment will be described with reference to the flowchart shown in FIG. 5.

When the system starts up in the information processing apparatus 1 (step A1), a DMA descriptor (including information such as a start address and the number of times of transfer) is set in the main memory 11. Then, an area for access from the input/output device is secured (step A2).

When a driver corresponding to the input/output controller 14 starts up (step A3), it starts up the input/output controller 14 (step A4).

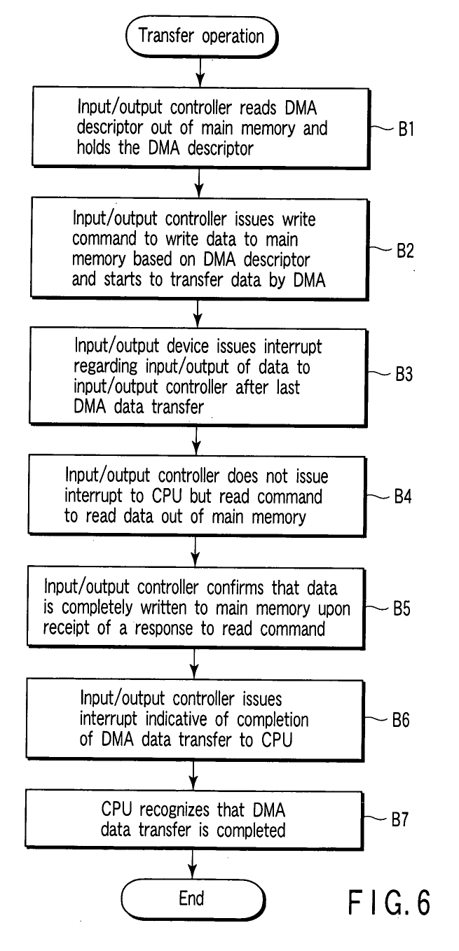

A DMA data transfer operation according to the present embodiment will be described with reference to the flowchart shown in FIG. 6.

The started input/output controller 14 reads a DMA descriptor from the main memory 11 and holds it (step B1).

Based on the DMA descriptor (including information such as a start address and the number of times of transfer), the input/output controller 14 issues to the second system bus 17 a write command to write data to the main memory 11 from the input/output device 13, and starts to transfer data by DMA (step B2). The write command is transmitted to the second bridge unit 19 through the second system bus 17 and then to the first bridge unit 18 through the first system bus 16. With the DMA data transfer function of each of the bridge units, data is transferred to the main memory 11.

After the input/output controller 14 receives the last data from the input/output device 13, the device 13 issues an interrupt (step B3). The input/output controller 14 transmits the interrupt to the interrupt controller 15 not immediately but after data has been written to the main memory 11 by DMA data transfer.

In order to confirm that data has been written to the main memory 11, the input/output controller 14 issues a read command to read data from a given area immediately after the input/output device 13 issues an interrupt (step B4). The read command is transmitted to the second bridge unit 19 through the second system bus 17 and then to the first bridge unit 18 through the first system bus 16. The first bridge unit 18 reads data corresponding to the read command from the main memory 11. The data read by the first bridge unit 18 is returned to the input/output controller 14 as a response to the read command.

In response to the returned data, the input/output controller 14 confirms that necessary data has been written to the main memory 11 (step B5) and issues an interrupt indicative of the completion of DMA data transfer (step B6). This interrupt is transmitted to the CPU 12 through the interrupt controller 15.

When the CPU 12 receives the interrupt, it recognizes the completion of DMA data transfer (step B7). Thus, the CPU 12 reads the transferred data from the main memory 11 when the need arises.

According to the embodiment of the present invention, when data is transferred from the input/output device 13 to the main memory 11 by DMA, the CPU 12 does not perform any read operation for the main memory 11 before all data is written to the main memory 11, with the result that data consistency can be secured with reliability, as described above.

As has been described in detail, the present invention allows data consistency to be secured with reliability when data is transferred between an input/output device and a memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A control apparatus comprising:
a memory;
a processor which is accessible to the memory;
an input/output controller which starts to transfer data from an input/output device to write the data to a given area in the memory not through the processor, reads data out of the given area in the memory after last data is transferred, and issues an interrupt indicative of completion of data transfer after confirming that all of the transferred data has been written to the memory by confirming a response; and
an interrupt controller which receives the interrupt from the input/output controller and transmits the interrupt to the processor.

2. The control apparatus according to claim 1, wherein the input/output controller includes a circuit which issues a read command to read data out of the given area in the memory after last data is transferred.

3. The control apparatus according to claim 1, wherein the input/output controller recognizes that data transfer is completed by confirming a response to an issued read command.

4. The control apparatus according to claim 1, wherein the data transfer is direct memory access (DMA) data transfer.

5. The control apparatus according to claim 1, wherein the input/output device is a hard disk drive.

6. An information processing apparatus comprising:
a memory;
a processor which is accessible to the memory;
a data transfer unit which transfers data to the memory not through the processor;
an input/output controller which starts to transfer data from an input/output device to write the data to a given area in the memory not through the processor but through the data transfer unit, reads data out of the given area in the memory after last data is transferred, and issues an interrupt indicative of completion of data transfer after confirming that all of the transferred data has been written to the memory; and
an interrupt controller which receives the interrupt from the input/output controller and transmits the interrupt to the processor.

7. A data transferring method applied to an apparatus including a memory and a processor accessible to the memory, the method comprising:
starting to transfer data from an input/output device to write the data to a given area in the memory not through the processor; and
reading data out of the given area in the memory after last data is transferred and transmitting an interrupt indicative of completion of data transfer to the processor after confirming that all of the transferred data has been written to the memory.

8. The method according to claim 7, further comprising issuing a read command to read data out of the given area in the memory after last data is transferred.

9. The method according to claim 7, further comprising recognizing that data transfer is completed by confirming a response to an issued read command.

10. The method according to claim 7, wherein the data transfer is direct memory access (DMA) data transfer.
